(19) United States
(12) Patent Application Publication
(10) Pub. No.: US 2004/0128238 A1
(43) Pub. Date: Jul. 1, 2004

(54) Adapt to destination locale

(76) Inventor: Oye Obe, New Rochelle, NY (US)

Correspondence Address: Oye Obe, 815 Serramonte Drive, Marietta, GA, 30068, US

(21) Appl. No.: 10/407,112

(22) Filed: Apr. 4, 2003

Related U.S. Application Data
(63) Continuation-in-part of application No. 10/335,570, filed on Dec. 30, 2002.

(51) Int. Cl. G06F 17/60

(52) U.S. Cl. 705/39

(57) ABSTRACT

The prepaid system comprises of a system center (host computer network) including an account database containing prepaid accounts, a PDL database containing specifications for rates and feature associated with preferred designation locales (PDL), and a card-type database containing default card specific data. The user connects to the system center by dialing an access number, the system center prompts the user to enter a personal identification number (PIN), the system center receives the PIN and determines if is valid. If the system center determines that the PIN is valid, the system center prompts the user to enter a destination number. The user also has the option to designate a PDL for the prepaid account. If the user designates a PDL, the system center records the PDL in the account database. Subsequently, the behavior of the prepaid account with respect to rates and other features is subject to the PDL designated for the prepaid account.

### BACKGROUND OF INVENTION

Remote-memory prepaid accounts are widely used for buying goods and services. In its most common form, a prepaid account includes a unique personal identification number (PIN) associating it with a wallet-size card imprinted with the PIN. The card is typically made of a printable substrate such as paper, paperboard or plastic, and may also be imprinted with instructions for accessing goods, services and other features of the prepaid account. A layer of scratch-off paint or other coating may be sprayed or applied by other means onto the card to temporarily conceal the PIN. Remote-memory prepaid account records are stored remotely on a system center (host computer network) and typically comprise such information as the current prepaid account balance in addition to the unique PIN.

The use of remote-memory prepaid phone cards for making long-distance telephone calls is particularly well known. The prepaid phone card provider maintains a toll free or local access phone number answered by a system center with associated telephone equipment including a telephone switch suitable for connecting a calling party to a destination number. A prepaid phone card is typically imprinted with a PIN, one or more access numbers and instructions for card-users to follow in order to place calls. The system center answers calls to the access number, and provides audio instructions prompting the card-user to enter a PIN. The system center validates the PIN and the current cash or time value associated with the prepaid phone account. Next, the card-user enters a destination party number and the system center connects the card-user to the destination party number, thereby placing the telephone call for the card-user. As a result, the prepaid account balance is reduced by the amount charged to the call.

Prepaid phone cards are often issued to promote sales to consumers whose calling needs are focused on a particular geographical location. These cards typically indicate one or more specific geographical locations and advertise low rates and fees for calls to the indicated continent, country, state, province or city.

However, these cards do not offer the card-user the opportunity to designate a preferred destination locale (PDL) within the geographic location/s indicated on the card. The ability to designate a preferred destination locale would make it possible for the provider to offer improved rates and features, tuned and tailored for making telephone calls to the PDL.

A system and method is thus needed to overcome the limitations of the prior art.

### SUMMARY OF INVENTION

This mechanism involves the use of preferred destination locales (PDL). A PDL is derived from the sequence of digits comprising a destination number. Typically, a PDL refers to a continent, county, state, region, province, city or other specified geographical location. A PDL could also refer to a characteristic such as destination device type i.e. mobile phone, pager, etc. Each PDL also comprises an associated set of rates and features applicable to a prepaid account.

The card-user establishes an authenticated connection to the system center by dialing an access number and entering a valid PIN. As a result, if a PDL is currently designated, a set of rates and features tuned and tailored specifically for the PDL is automatically imposed on further activity associated with the prepaid card account. Subsequently, the card-user has the ability to change the PDL or to perform supported transactions such as completing long-distance calls.

Also, the ability to designate a card for a particular locale means a wider range of customers can be served by a reduced number of card-types, where each card-type covers multiple PDL's.

For example a prepaid card issued for the South Sea Islands would provide users the option to designate any of islands (Tonga, Samoa, Kiribati, Tahiti, Cook Islands, Vanuatu . . . ) as their PDL. Hence, a user intending to make calls mostly or exclusively to Kiribati would designate Kiribati as their PDL in order to receive rates and features tuned by the card provider for improved value to that island destination.

### BRIEF DESCRIPTION OF DRAWINGS

FIG. 1A is a view of one side of an exemplary prepaid card according to the invention.

FIG. 1B is view of the reverse side of the prepaid card of FIG. 1A.

FIG. 2 is a schematic diagram of an exemplary system center according to the invention.

FIG. 3 is a representation of data records stored in the system center according to the invention.

FIG. 4 is a flowchart showing an exemplary sequence for adapting and using a prepaid account according to the invention.

### DETAILED DESCRIPTION

The preferred exemplary embodiment below and in the accompanying drawings surrounds a remote-memory prepaid telephone card. However, the invention contemplates virtually any type of transaction card instrument or methodology for virtually any type of goods or services of whatever kind or nature.

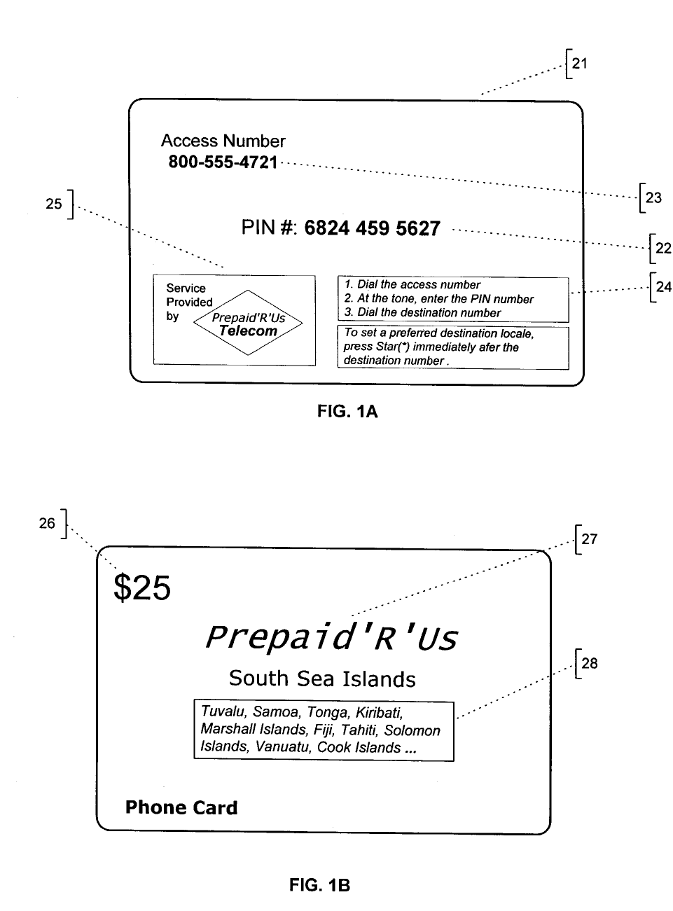

Referring now to FIG. 1A, an exemplary prepaid card 21 is analogous in its physical embodiment to a credit card-like instrument, being comprised here of printable paper substrate. In a preferred embodiment, card 21 is 8.6 cm in length, 5.4 cm broad, and has a thickness of 0.75 mm. With continued reference to FIG. 1A, prepaid card 21 comprises an access telephone number 23 for accessing a prepaid service provider's system center and a personal identification number (PIN) 22 for accessing the cards associated prepaid account. Access telephone number 23 may be a toll-free 800 number or a local phone number. PIN 22 is a numeric or alphanumeric code preferably unique to a particular telephone card.

With continued reference to FIG. 1A, instructions 24 may be set forth on card 21 explaining how to place phone calls through the system center. Additional information, drawings, photographs, letters or designs 25 may be suitably printed on card 21.

Referring now to FIG. 1B, the opposite side of prepaid card 21 comprises a visual indicia 27, which may include drawings, photographs, letters or other designs. A number 26 may be printed on prepaid card 21 to indicate the value or initial balance amount associated with prepaid card 21. This amount may be in currency or may be in card units. Usage of card 21 reduces the balance in the account by the telephone charges accrued. Prepaid card 21 provides improved value for calls to destinations 28 indicated on the card.

This embodiment illustrates a prepaid card supporting the designation of one PDL at a time. It will be apparent however to those skilled in the art, upon viewing the specifications and drawings, that various modifications and variations including the use of multiple concurrent PDL's can be made without departing from the scope or spirit of the invention.

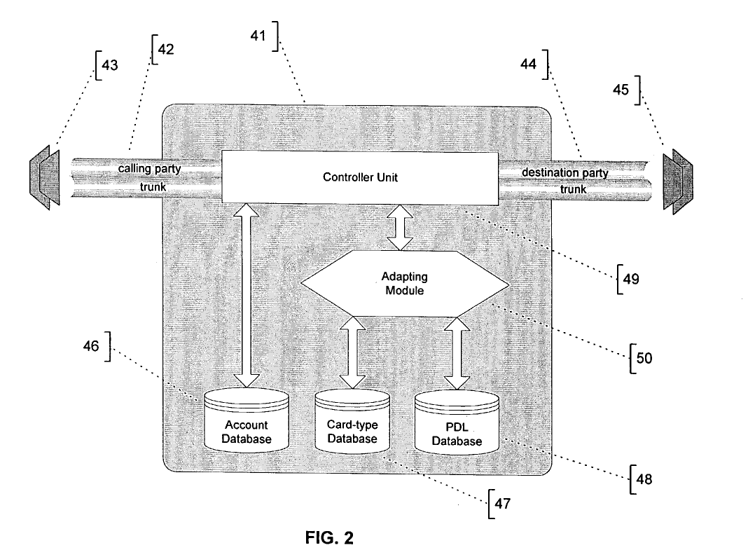

Referring now to FIG. 2, a system center (host computer network) 41 for use with prepaid card 21 comprises an account database 46 containing prepaid account data, a card-type database 47 containing parameters for the prepaid card 21 including a default PDL used in the absence of PDL adaptation, and a PDL database 48 for storing specifications for the PDL's. Databases 46, 47 and 48 may be included in a single database structure or may be separate, individual databases. The system center 41 also provides various functions including call switching, call routing, call record creation, call processing, and management and control of the various accounts associated with prepaid calling.

With continued reference to FIG. 2, system center 41 suitably comprises an inbound call trunk 42, an outbound call trunk 44, a controller unit 49, an adapting module 50, and associated memory means such as random access memory (RAM), a tape drive, a magnetic drive, a compact disc or the like. Trunk 42 represents just one of multiple incoming telephone lines grouped to serve the same access telephone number. When a card-user places a call from a calling station such as a telephone 43, card-user is connected to system center 41. Controller unit 49 routes the call through communications trunk 44 to called station 45. Controller unit 49 also monitors the call connection. The adapting module 50 manages the flow and processing of data to and from card-type database 47 and PDL database 48.

In accordance with the present invention, a prepaid service provider or telephone company or other entity issuing telephone card 21 may suitably perform the functions of system center 41. Those skilled in the art will appreciate that system center 41 includes suitable computing hardware and software for effecting the functions set forth herein.

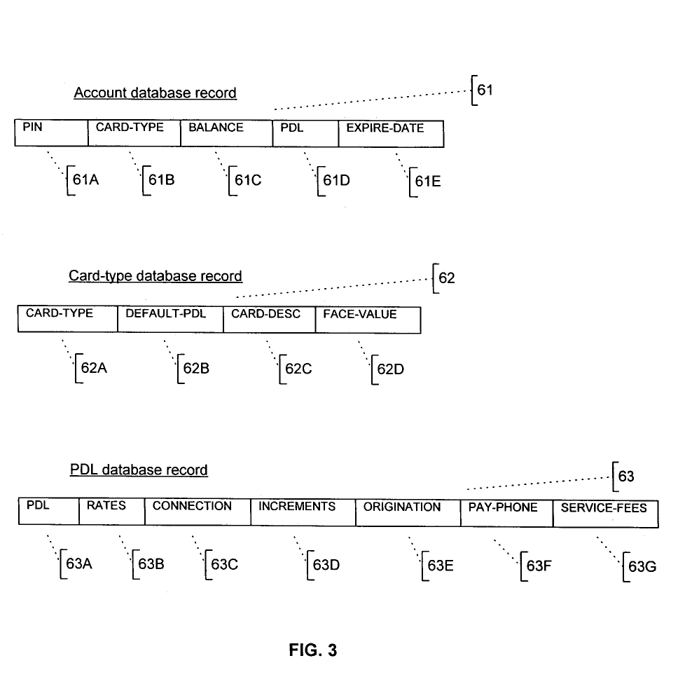

Referring now to FIG. 3, in accordance with the preferred embodiment, the data associated with prepaid card 21, and its corresponding preferred destination locales (PDL) are reduced into databases 46, 47 and 48 whereby:

1) PIN data is represented as database record 61 of account database 46

2) card specific data is represented as database record 62 of card-type database 47

3) PDL data is represented as database record 63 of PDL database 48

To determine the PDL adaptation in effect for an account, the system center fetches the PIN record 61 from the account database 46 using the entered PIN 22 as key, extracts PDL 61D and fetches the PDL record 63 corresponding to PDL 61D. Fields 63B-63G constitute the PDL adaptation in effect for the prepaid account.

If a PDL has not been entered, PIN record 61 will not contain a value for the PDL 61D field. In this situation, CARD-TYPE 61B is extracted from PIN record 61. Next the system center fetches the corresponding CARD-TYPE record 62 from card-type database 47 using the extracted CARD-TYPE 61B as key. The DEFAULT-PDL 62B is then used instead to fetch the corresponding PDL record constituting the default rates and features associated with the prepaid card.

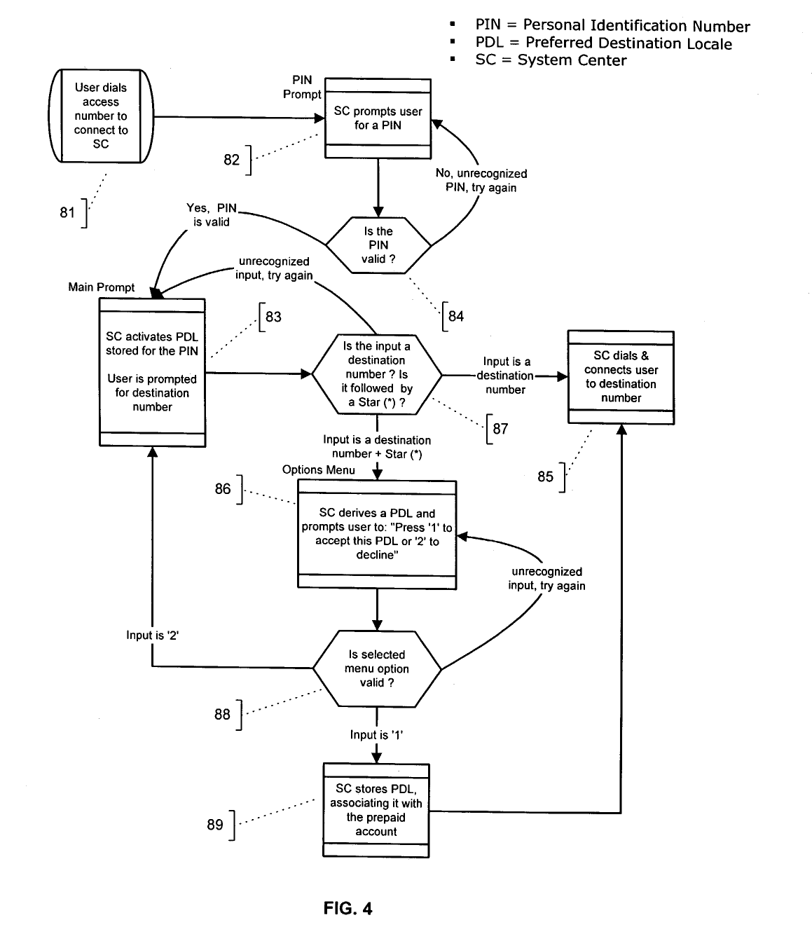

Referring now specifically to the flowchart of FIG. 4 and with references to FIGS. 1-3 described above, an exemplary method for providing PDL adaptation for a prepaid account in the context of a prepaid phone card system is explained. A preferred embodiment comprises the following methodology implemented by a computer readable program code that is stored in a computer usable medium such as memory and executed by controller unit 49.

The card-user in possession of calling card 21 uses calling station 43 to dial access number 23. After card-user from calling station 43 connects to system center 41 as shown at block 81, the system center at block 82 prompts the card-user for PIN 22. This prompt may be a tone that the card-user recognizes as a prompt for PIN 22, or audio instructions instructing the card-user to input PIN 22.

With continued reference to FIG. 4, upon receipt of PIN 22, system center 41 at block 84, accesses account database 46 to determine if PIN 22 is valid (i.e. the PIN is checked to confirm that such a number exists and that there is money or credit units remaining in the account). If PIN 22 is not valid as shown at block 84, system center 41 informs the card-user that PIN 22 is invalid and requests another PIN at block 82. If the PIN is determined to be valid, system center goes to Main Menu block 83 and accesses database 46 to fetch the PDL currently entered for the prepaid card account. Hence, PIN 22 is used as key to access database 46 in order to fetch the PDL. Then system center 41 activates the PDL for the prepaid account and prompts the card-user to enter a destination phone number.

If the card-user enters a destination number followed by a Star (“*”) as shown at block 87, system center 41 goes to options menu block 86 and derives a PDL from the entered destination number. In the exemplary embodiment, options menu block 86 prompts the card-user to accept or decline the PDL.

If the card-user chooses to accept the PDL as shown at block 88, system center 41 at block 89 records the PDL in field 61D in database 46. Hence subsequent activity on the prepaid account is subjected to the PDL and its associated rates and features.

Next, system center 41 proceeds from block 89 to block 85 where it dials the destination number to connect the card-user to the destination party over communications link 44.

While FIG. 4 shows the present invention as incorporated with a prepaid calling card system, it is important to remember that the present invention contemplates systems that use other types of transaction cards. The embodiment shown in FIG. 4 should not be interpreted as being limited to prepaid telephone cards.

In accordance with another embodiment, the card-user designates a PDL by entering a destination-code corresponding to the desired PDL. A destination-code is a sequence of digits that may comprise a country-code, area-code, city-code or the like, indicating the desired PDL or a range of destination numbers within the desired PDL.

Another embodiment involves an additional database, the modifications database. This database tracks modifications by the calling party to their choice of PDL. The data stored for each modification includes the PIN, the type of modification and the time of modification, enabling the system center to determine when conditions are met for restricting the calling party's ability to modify their choice of PDL.

The invention set forth herein in the context of the appended drawing figures is not limited to the specific forms shown. Various other modifications, variations, and enhancements in the design and arrangement of the suite, system center and the like as set forth herein may be made without departing from the spirit and scope of the present invention as set forth in the appended claims.

What is claimed is:

1) A method used by a system center for adapting the rates and features of a prepaid account using preferred destination locales (PDL), comprising the steps of:
a. connecting the calling party's telephone device to the system center;
b. calling party enters the prepaid account PIN by selecting the corresponding keys on the telephone device;
c. receiving said PIN from the calling party by the system center, and determining that said PIN represents a valid prepaid account;
d. all further activity is subjected by the system center to the rates and features corresponding to the PDL previously designated by the calling party for said prepaid account;
e. prompting the calling party for a destination number;
f. connecting the calling party to the destination telephone number; and
g. reducing the available balance for said prepaid account as amounts are charged to the call during duration of the call.

2) The method of claim 1 wherein step (d) is instead performed after step (e) and prior to step (f).

3) The method of claim 1 wherein step (d) is instead performed after step (f) and prior to step (g).

4) The method of claim 1, 2 or 3 wherein step (e) is practiced by the following steps:
i. prompting the calling party for a destination number;
ii. entering by calling party of a destination number;
iii. system center derives a PDL from said destination number;
iv. system center stores association between said derived PDL and said prepaid account;

5) The method of claim 1, 2 or 3 wherein step (e) is practiced by the following steps:
i. prompting the calling party for a destination-code;
ii. entering by calling party of a destination-code corresponding to a desired PDL;
iii. system center derives a PDL from said destination-code;
iv. system center stores association between said derived PDL and said prepaid account;
v. prompting the calling party for a destination number;

6) A computer system for making prepaid telephone calls between a calling party and a destination party comprising:
incoming and outgoing telecommunication trunks configured to connect the calling party and destination party to said computer system;
an account database configured to store information associated with prepaid accounts;
preferred destination locales (PDL) each configured with rates and features that are applicable to a prepaid account;
a PDL database configured to store PDL's and their associated rates and features;
a central processing unit configured to receive calling party's PIN, use said PIN to determine the prepaid account and PDL associated with said PIN, and connect the calling party to the destination party;
a means for subjecting activity on the prepaid account to the rates and features associated with the PDL;
a means for enabling the calling party to designate a choice of said PDL while connected to said computer system;
a means for storing an association between said derived PDL and said prepaid account; and
a means for deriving a PDL from a sequence of digits entered by the calling-party.

7) The computer system of claim 6 wherein said sequence of digits entered by the calling party, from which said computer system derives a PDL, comprises a destination number.

8) The computer system of claim 6 wherein said sequence of digits entered by the calling party, from which said computer system derives a PDL, comprises a destination-code corresponding to a PDL.

9) The computer system of claim 6, 7 or 8 further comprising a means for restricting the calling party's ability to designate a choice of PDL.
